(19) United States
(12) Patent Application Publication
(10) Pub. No.: US 2023/0011054 A1
(43) Pub. Date: Jan. 12, 2023

(54) WIDE SLOT DIE AND METHOD FOR OPERATING A WIDE SLOT DIE

(71) Applicant: FMP Technology GmbH Fluid Measurements & Projects, Erlangen (DE)

(72) Inventor: Gerald BETZ, Nürnberg (DE)

(21) Appl. No.: 17/786,601

(22) PCT Filed: Dec. 2, 2020
(86) PCT No.: PCT/EP2020/084277

§ 371 Date: Jun. 17, 2022

(30) Foreign Application Priority Data
Dec. 19, 2019 (DE) 102019220151.2

(51) Int. Cl. B05C 5/02; B05D 1/26

(52) U.S. Cl. CPC B05C 5/0254; B05D 1/26; H01M 4/0404

(57) ABSTRACT

The present disclosure relates to a wide slot die for applying a fluid provided with particles, having a die body. The die body comprises a die interior chamber for receiving the fluid provided with particles. The fluid provided with the particles can be discharged via a die gap, which is bounded by two walls, onto a substrate which is in motion relative to the wide slot die in a transport direction. A vibration device is mechanically coupled to the die body in order to vibrate the die gap and the fluid located in the die interior chamber and provided with the particles. The vibration device is adapted to excite the die body with an upper limit frequency of at most 1 kHz.

### CROSS REFERENCE TO RELATED APPLICATIONS

This application is a national phase of PCT Application No. PCT/EP2020/084277 filed on Dec. 2, 2020, which claims the benefit of and priority to German Patent Application No. 10 2019 220 151.2, filed on Dec. 19, 2019, each of which are hereby incorporated by reference herein in their entirety.

### TECHNICAL FIELD

The present disclosure relates to a wide slot die for applying a fluid provided with particles and a method for operating such a wide slot die.

### BACKGROUND INFORMATION

For coating flat substrates, such as foils made of plastic, aluminum or paper, a wide variety of materials, such as adhesives, coatings or functional media, are provided across the surface of the substrates in wet film thicknesses between 1 μm and up to 5 mm. Spraying, squeegeeing and dipping methods can be used to apply the media. Another method is the so-called slot die coating. In this case, the medium to be coated is fed to a so-called slot die (slot nozzle) by means of a pump or a pressure vessel. The slot die is arranged to distribute the medium to be applied across the width of the die. The fluid then exits through a high-precision die gap (known as a slot or nozzle slot) and is applied to the substrate to be coated. Since the width of the die gap can be up to 5 m, such a slot die is also referred to as a wide slot die. The slot die method is a so-called full-surface coating method. The application thickness of the coating fluid is ensured by the design of the die interior and the mass continuity. This method is used in a wide variety of industrial fields, for example in the paper and packaging industries, in the field of battery and fuel cell production, and for the manufacture of optically active and electronic components.

Depending on the case of application, the media used for coating can be provided with particles (solids). One problem in the processing of such media is that, due to their size, the particles usually tend to agglomerate significantly and in some cases also to sediment. If such behavior is present, sedimentation zones and accumulations of agglomerates can occur in the wide slot die. If agglomerates get into the die gap due to the flow or if deposits build up directly in the area of the gap, this leads to coating defects. This results in uneven transverse and longitudinal distribution of the medium on the substrate to be coated. If poor uniform distribution or even blocking of the die gap occurs, up to now, the coating process must be interrupted and the die cleaned. This results in long downtimes and also fluctuations in the quality of the products.

DE 10 2009 017 453 A1 discloses a gap die for spraying a liquid which can be adapted to different properties of the liquids to be sprayed. The gap die enables the processing of liquids of different viscosities and with different contents of solids. The gap die proposed there has two spray air gaps which are arranged on both sides of a central liquid gap and via which spray air can be discharged for atomizing the liquid, wherein a structure is arranged in the liquid gap which is formed as a comb-like intermediate layer. This structure is placed between the two walls bounding the liquid gap, wherein teeth of the intermediate layer extend towards an orifice of the liquid gap. This allows the gap width to be varied so that different comb-like intermediate layers are placed between the two walls bounding the liquid gap. For processing liquids with a high content of solids, the comb-like intermediate layer is coupled with an agitation, with agitation amplitudes of 1/100 mm being suggested as a maximum.

CA 869959 proposes a coating device that uses ultrasound to vibrate a die discharging the coating material. This is to keep the die gap free of debris and agglomerating coating material. The use of vibrations in the ultrasonic range is preferred because low frequencies and large mechanical deflections can adversely cause a vessel containing the coating material to begin to move, which can result in reduced coating quality. The die gap is no more than 0.5 inch, i. e., about 13 mm, wide.

It is the object of the present disclosure to provide a wide slot die for applying a fluid provided with particles, as well as a method for operating a wide slot die, which are structurally and/or functionally improved so that the agglomeration and sedimentation behavior of particles in the die can be avoided or reduced during coating.

These objects are solved by a wide slot die according to the features of claim 1 and a method for operating the wide slot die according to the features of claim 11. Advantageous embodiments are set forth in the dependent claims.

In accordance with a first aspect of the present disclosure, a wide slot die for applying a fluid provided with particles is proposed. The fluid provided with particles, also referred to as a coating fluid, comprises one or more different liquids, e.g. solvents, and one or more different solid materials. The solid material(s) are contained in the fluid(s) as particles of the same and/or different size and with regular and/or irregular surface. The selection of liquids, materials, particle sizes and compositions depends on the case of application.

### SUMMARY

The wide slot die comprises a die body, wherein the die body comprises a die interior chamber for receiving the fluid (coating fluid) provided with particles. In particular, the die body may be formed from two die halves, with the die interior chamber formed between the die halves. In addition to the two die halves, the die body may also comprise other components. Metal foils of predetermined thickness, for example, are arranged between the die halves. The die interior chamber may have any shape, as viewed in a cross-section, wherein the die interior chamber may comprise a plurality of chambers. For example, the die interior chamber may have a substantially circular or teardrop-shaped cross-section. Sectional combinations thereof may also be provided. In cross-section, the design of the die interior chamber may change or be constant.

The fluid provided with the particles can be discharged via a die gap, which is bounded by two walls, onto a flat substrate which is in motion relative to the wide slot die in a transport direction. The die gap is formed in particular between the halves of the die. In the case of a metal foil arranged between the die halves, the gap width results from the thickness of the metal foil, which is therefore also referred to as a die foil. In cross-section, the design of the die gap can change or be constant. The length of the die gap is preferably constant. The fluid provided with the particles flows through the interior chamber of the die and then into the die gap. From there, it flows to exit a so-called die lip and is applied onto the substrate, which has a relative velocity with respect to the wide slot die. The relative motion between the wide slot die and the substrate includes a movement of the substrate relative to the wide slot die. For example, the substrate may be coated in a known reel-to-reel method such that there is a movement of the substrate in the transport direction, while the wide slot die may be stationary. Alternatively or additionally, the wide slot die can be moved relative to the substrate. The substrate can be in the form of a sheet, for example, in which case the die body and the wide slot die are moved relative to the substrate in the transport direction.

The substrate to be coated can be made of any material or combination of materials. For example, the flat substrate can be a foil made of plastic, aluminum, textile or paper.

The shape of the die gap is individually designed for a particular application. The design of the die gap can depend, for example, on the type and/or composition of the coating fluid. Further influencing parameters can be the application speed of the coating fluid onto the substrate and a pressure drop to be achieved across the die gap. Depending on the particular case of application, the size and/or shape of inner and outer lips of the die gap as well as the geometric transition of the die gap to the interior chamber can be individually designed.

The wide slot die further comprises a vibration device mechanically coupled to the die body to vibrate the die gap and the fluid (coating fluid) located in the die interior chamber and provided with the particles. The vibration device may be actuated by compressed air, hydraulically or electrically. According to the present disclosure, the vibration device is adapted to excite the die body with an upper limit frequency of at most 1 kHz.

The vibration unit, which generates mechanical vibrations due to mass inertia, causes the inherently stationary die body with its wide slot die and the coating fluid located in the die interior chamber to vibrate. It was surprisingly found that a tendency to agglomeration and sedimentation of the particles contained in the fluid can be reliably prevented if the vibration device is excited at a frequency significantly below ultrasound, in particular at an upper limit frequency of at most 1 kHz.

This is based on the observation that the occurrence of agglomerations of the particles contained in the fluid leads to deposits on the walls, in particular in the area of the transition between the die interior chamber and the die gap. After a certain period of operation of the wide slot die, the deposits in this area result, at least in sections, in blocking of the die gap from the die interior chamber. The development of agglomerates of particles is related to the gravitational field and the momentum exchange in the flow, which the particles experience with each other and with the wall. Thus, the formation of the agglomerates depends on local flow conditions, a plurality of material data and interactions, the characteristics of the particle fractions and the ambient conditions, and cannot be predicted.

In order to suppress the agglomeration and/or sedimentation tendency, sufficiently high kinetic energy is introduced into the wide slot die and thus into the coating fluid therein by the vibration device, which operates at comparatively low frequencies. This enables the additional momentum exchange to stabilize the fluid and to homogenize it in conjunction with the flow. As a result of the vibrations in the frequency range of at most 1 kHz, it is possible to reduce particle agglomerates or to break them up by means of shear forces in the flow for entry into the die gap. The same applies to the buildup of agglomerates and the formation of sedimentation zones. The vibration device thus enables these energy components to be increased without affecting the process stability of the coating. As a result, coating can be carried out without interruption and thus with constant quality.

According to example embodiments, the vibration device is adapted to excite the die body with a lower limit frequency of at least 1 Hz. The frequency range used by the vibration device is thus between 1 Hz and 1 kHz. A preferred frequency range is in the order of 60 Hz to 70 Hz. The frequency selected may depend on aspects of the wide slot die as well as the properties of the coating fluid, in particular the particle properties (size and/or particle size distribution) and their concentrations. Density differences of particles in the fluid and adhesion forces between particles themselves and the inner walls of the die strongly determine the processes. The appropriate frequency may be different for different types and/or compositions of coating fluids. The frequency suitable for a particular coating fluid can be found, in particular, by experimentation. Other parameters that can influence the optimum frequency or frequency range are furthermore the position of the vibration unit on the die, the local flow conditions and the application method used with the wide slot die. The shape of the die gap can also influence the optimum frequency.

According to example embodiments, the mechanical amplitude of the vibration device is greater than or equal to 0.1 in relation to the nominal diameter of the particles contained in the fluid. In particular, it is useful if the mechanical amplitude of the vibration device is at most 5 mm. In the case of particle size distributions, an amplitude for the largest particle diameter can be determined comprehensively. Here, an amplitude is defined as a full oscillation length of the vibration device from one end to the other end (peak-to-peak). However, this does not exclude the selection of smaller amplitudes corresponding to the particle size distribution range from the application of the process principle, since an excitation of particle fractions can serve the purpose just as well. The mechanical amplitude of the vibration device strongly depends on shape, mounting and mass of the wide slot die. In particular, amplitudes in the die body are dependent on location and frequency. A suitable mechanical amplitude is also limited by the need for a defect-free application onto the substrate moving relative to the die. The suitable mechanical amplitude can be found, for example, by experimentation.

The following considerations can be taken into account: The mechanical amplitude of the vibration device is proportional to the maximum acceleration forces, which in turn are approximately proportional to the forces acting on the particles. The higher the acceleration, the better the intended effect. The criterion in the following equation is a de-dimensioned illustration of the acceleration with respect to the gravity acceleration g. The value 100 is considered to be an appropriate upper limit.

$$\frac{{a}_{max}}{g} \leq 100$$

In connection with the equation for the acceleration a=\ddot{x}(t)

\ddot{x}(t)=−4\check{A}π²f² sin(2πft)

the upper limit value for the maximum amplitude of the vibration device can be determined. The maximum is the value for sin=1 or −1, where the maximum acceleration is aₘₐₓ=4 \check{A}π²f². Here, \check{A} is half of the peak-to-peak amplitude, and f is the frequency at which the vibration device is operated.

The use of the vibration unit allows to minimize the factor between maximum particle size and selectable die gap under the given conditions. This allows larger particle fractions to be used without jeopardizing the uniform application of the wide slot die. The vibrations homogenize the flow behavior and stabilize the fluid state, enabling better processing and process stability. In addition, the influence of the manufacturing tolerances of the inner surfaces of the die on the flow process can be reduced by the vibration. Thus, the homogeneity of the wet film of the coating fluid in width and length can be realized or optimized by the introduced mechanical vibrations.

According to example embodiments, the mechanical amplitude of the vibration device acts on the die body in a direction corresponding to the transport direction of the substrate. Alternatively or additionally, the mechanical amplitude of the vibration device may act in the main flow direction (i.e., height direction) and further along the die body (i.e., in its width direction). Vibration with mechanical amplitudes in one or more spatial directions reduces or prevents the formation of agglomerates and/or sedimentation zones in the fluid or on the inner surfaces of the die. This can prevent coating defects and clogging of the die gap.

According to example embodiments, the wide slot die described above is used to apply a structurally viscous coating fluid onto the substrate. Almost all coating fluids, especially those with particles, exhibit a so-called structure-viscous behavior. This means that the viscosity is not a material constant but, in addition to pressure and temperature, also depends on the shear and the duration of a shear. Characteristic of a structurally viscous behavior is an increasing reduction of viscosity with incipient shear. Additionally, the course of viscosity as a function of shear varies. An intrinsic viscosity can appear, but local maxima and a sharp increase in viscosity are also possible. This fluid behavior, which is sensitive in some cases, can adversely affect the transverse distribution of the fluid in the wide slot die in conjunction with the manufacturing accuracy of the die, in particular the die inner surfaces and the die lip. The use of the vibration device has a homogenizing and stabilizing effect on the fluid. This reduces, for example, the inlet length and local boundary layer in the die gap. The flow conditions are thus more homogeneous in the cross-section. The influence of the manufacturing accuracy on the uniform distribution can thus be reduced, depending on the case of application. As a result, an improvement in the transverse distribution is generally possible with the same manufacturing accuracy.

According to example embodiments, the die gap has a width of between 10 mm and 5 m in a width direction extending transverse to the transport direction. The die gap preferably has an exclusively linear, i.e. straight, extension, but can be curved, for example, in the width direction extending transverse to the transport direction.

According to example embodiments, the die gap has a slot width of between 10 μm and 2.5 mm. The slot width is selected in particular as a function of the size of the particles contained in the coating fluid. The nominal diameter of the particles must generally be smaller than the selected slot width. Mathematically, a slot width of 200 μm results in a maximum particle size of 200 μm. In practice, however, the particles must be smaller, as otherwise the die would immediately become clogged. The described vibration unit allows to improve the tolerance for large particles and high particle concentrations.

According to example embodiments, a fastening device of the wide slot die, to which the die body is mechanically fixed, is mounted via damper elements. This ensures that the vibrations generated by the vibration device can act in the desired manner exclusively or largely on the die body and the coating fluid contained therein.

According to a second aspect of the present disclosure, a method for operating a wide slot die according to one or more embodiments is proposed. In this method, the vibration device is actuated such that the die body is excited with an upper limit frequency of at most 1 kHz. The method has the same advantages as described above in connection with the device according to the present disclosure.

According to example embodiments, the die body is excited with a lower limit frequency of at least 1 Hz.

According to example embodiments, the mechanical amplitude of the vibration device is set to be greater than or equal to 0.1 in relation to the nominal diameter of the particles contained in the fluid. In particular, the mechanical amplitude of the vibration device is set to be at most 5 mm.

Further characteristics and advantages of the present disclosure are described below with reference to the drawing, in which:

### BRIEF DESCRIPTION OF THE DRAWINGS

FIG. 1 shows a cross-section through a wide slot die according to the present disclosure, which is mounted on a fastening device;

FIG. 2 shows a side view of the wide slot die of FIG. 1;

FIG. 3 shows a cross-section along line III-III through the wide slot die of FIG. 2, wherein a vibration device is mechanically coupled to the wide slot die; and

FIG. 4 shows a partial cross-section through the fastening device of the wide slot die of FIG. 2.

### DETAILED DESCRIPTION

FIG. 1 shows a wide slot die 1 according to the present disclosure for applying a fluid provided with particles onto a substrate 20, which is arranged below wide slot die 1. The distance between substrate 20 and wide slot die 1, as well as the components of wide slot die 1, are not shown to scale for drawing reasons. The fluid is hereinafter referred to as the coating fluid. Next to wide slot die 1, a coordinate system is shown in which q denotes a transverse direction, h denotes a height direction, and b denotes a width direction of wide slot die 1. The transverse direction q extends in a direction corresponding to a transport direction TR of substrate 20. The width direction b extends in a plane defined by the transverse and width directions transverse to the transport direction TR.

The coating fluid contains one or more different liquids, e.g. one or more solvents, and one or more particulate solids. Concentration, size, density and shape of particles in the coating fluid are selected according to a present application. Commonly encountered cases of application are shown at the end of the description.

Wide slot die 1 comprises a die body 2 which, for example, is formed from two die halves 3, 4. A die interior chamber 6 is formed between die halves 3, 4, which in the cross-sectional view shown is only exemplarily in the shape of a circle. A die foil 5 of predetermined thickness is arranged between die halves 3, 4. This defines the slot width of a die gap 7 in the lower region of die body 2 between opposing walls 7a, 7b of respective die halves 3, 4 and, together with die halves 3, 4, encloses the fluid located in die interior chamber 6. Die foil 5 has a recess for die interior chamber 6 and die gap 7 corresponding to the required coating width in the width direction b. The slot width of die gap 7 thus corresponds to the thickness of die foil 5. In the case of application, the slot width is selected such that the wide slot die essentially allows the desired uniform distribution by means of sufficient pressure drop of the die gap. However, the minimum die gap width is limited by the particles present in the fluid. In this case, the slot width is always at least slightly larger than the particle size of the particles contained in the coating fluid. Preferably, die gap 7 has a slot width of between 10 μm and 2.5 mm.

The coating fluid located in die interior chamber 6, which is conveyed via one or more inlets not explicitly shown, can be discharged through a die gap opening 7L onto a substrate 20 moving relative to wide slot die 1 in transport direction TR. Substrate 20 is a flat substrate, for example a foil made of plastic, aluminum or paper or another material to be coated. The distance between substrate 20 and a die lip 9 facing the side of substrate 20 to be coated can be between a few micrometers and a few centimeters.

Die gap 7 can have a width of between 10 mm and 5 m in the width direction b, depending on the selected application.

The selection of die gap 7, essentially the gap length (i.e., the length required by the fluid from the inner chamber to the exit) and the gap width, depends on the coating fluid and the desired process and operating conditions. The coating fluid is applied at the exit point between two die lips 9 and substrate 20. For a selected operating point, a uniform distribution caused predominantly by the viscous forces can thus be achieved with a wide slot die. A large part of the resulting pressure drop is caused by the fluid flowing through die gap 7, which leads to large pressure forces from inside to the die body. This pressure drop is specifically adjusted to achieve a uniform distribution, but is technically limited by the elasticity values of the materials of the die body. Excessively high viscosities can thus lead to a deflection of the die gap and subsequently result in an influence on the uniform distribution.

Die body 2 is mechanically connected to a fastening device 10. Fastening device 10 comprises a first retaining element 11 and a second retaining element 12. First retaining element 11 has a retaining extension 11F. Second retaining element 12 has an engagement extension 12F corresponding thereto. Second retaining element 12 is mechanically connected to die half 4, for example. The second retaining element with die body 2 attached thereto can be brought into engagement with first retaining element 11 by engagement extension 12F. First and second retaining elements 11, 12 are mechanically connected to each other by a fixing element 13 which clamps engagement extension 12F and retaining extension 11F. The illustrated retainer is thus only exemplarily designed as a so-called dovetail. Which retainer is actually selected is not specified in more detail.

In order to prevent a transmission of vibrations from second retaining element 12 to first retaining element 11 by a vibration device 16 described in more detail below, a damper element 14 is provided between first retaining element 11 and second retaining element 12, and a damper element 15 is provided between second retaining element 12 and fixing element 13.

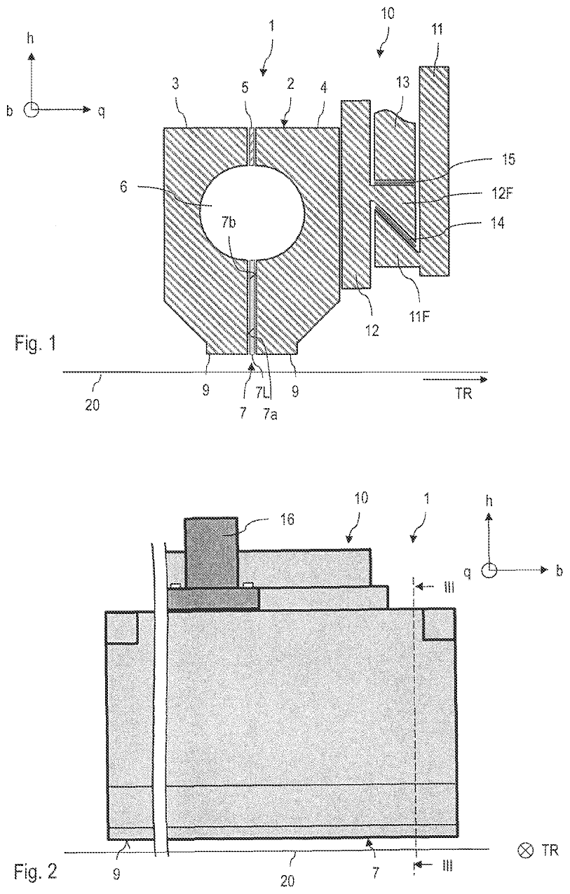

In each of FIG. 2 to FIG. 4, which illustrate different details of wide slot die 1 of FIG. 1, vibration device 16 is shown which is mechanically coupled to die body 2. Vibration device 16, which is operated by compressed air, hydraulically or electrically, for example, is arranged on a side of die body 2 facing away from die gap 7. The mechanical attachment can be made, for example, by means of screws and the like.

Vibration device 16 is adapted to cause die body 2 and thus die gap 7 and the coating fluid in die interior chamber 6 to vibrate. Vibration device 16 is designed such that the mechanical amplitude is generated primarily in the transverse direction q and the height direction h of die body 2. Alternatively or additionally, a mechanical amplitude can also be generated by the vibration device in the width direction b of die body 2. Preferably, vibration device 16 is adapted and operated such that the mechanical amplitude acts both in the transverse direction q and in the height direction h.

The mechanical amplitude of vibration device 16 is greater than or equal to 0.1 in relation to the nominal diameter of the particles contained in the fluid. Preferably, the mechanical amplitude of vibration device 16 is at most 5 mm. In the case of particle size distributions, the amplitude can be determined by the largest particle diameter. However, this does not exclude the selection of smaller amplitudes corresponding to the particle size distribution range from the application of the process principle, since an excitation of particle fractions can equally serve the purpose. In this case, the vibration device is operated at a frequency in a range between 1 Hz and 1 kHz. The optimum frequency and the exact mechanical deflection of an application depend on a plurality of parameters. The shape and material of wide slot die 1, the shape of die interior chamber 6 and die gap 7, the coating fluid and its flow all play a role. The application point at die gap opening 7L and the two die lips 9 are typically wetted with the coating fluid during coating. In interaction with the relative velocity of substrate 20, this creates a fluid contingent upstream of the die gap that is enclosed by the contact with die lip 9 and is also excited, and thus, also determines the process.

Vibration device 16 introduces kinetic energy into die body 2 and the coating fluid by means of mechanical amplitudes. This allows to stabilize the fluid by means of the additional momentum exchange and to homogenize it in connection with the flow. Furthermore, agglomerates of particles contained in the coating fluid can be broken up and sedimentation zones in die interior chamber 6 can be avoided. Likewise, the buildup of particle agglomerates can be avoided by the kinetic energy introduced. By means of vibration device 16, it is thus possible to increase the kinetic energy components without significantly influencing the process stability of the coating process.

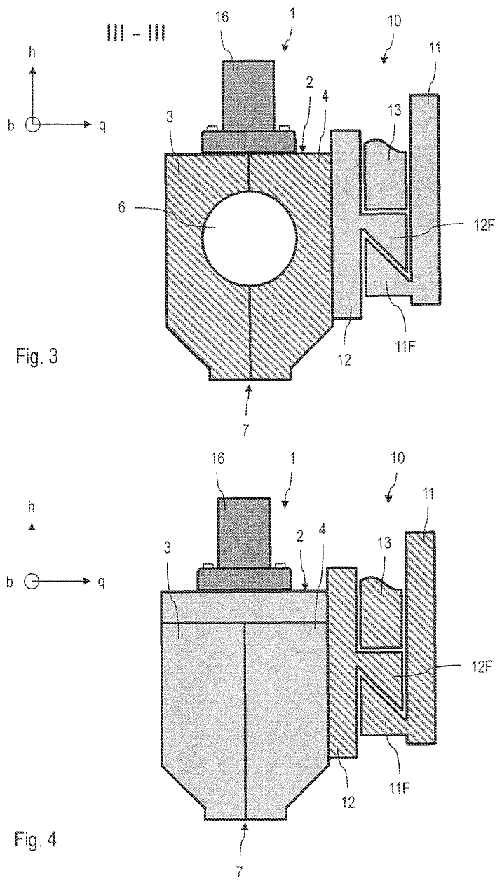

FIG. 3 and FIG. 4 each show different partial cross-sections through wide slot die 1 of FIG. 2. While FIG. 3 shows a cross-section through die body 2 (with die gap 7 not explicitly shown in this illustration), FIG. 4 shows a partial cross-section through fastening device 10, with die body 2 shown uncut.

The process-technical basis of the uniform full-surface application of the coating fluid by means of wide slot die 1 is the pressure drop generated in die gap 7. The pressure drop is essentially created by die gap 7, the connection of die interior chamber 6 with die gap opening 7L and the exit point of the coating fluid from die gap opening 7L. The pressure drop for a sufficient uniform distribution on substrate 20 can be achieved by selecting die foil 5 whose thickness is equivalent to the slot width of the exit gap, i.e., die gap opening 7L. Substantially, the pressure drop is limited by the mechanical deflection of wide slot die 1 due to pressure forces.

The achievement of a sufficiently large pressure drop, and thus, a good transverse distribution or uniformity of the layer to be produced on the substrate 20 results from the relationship between the desired application speed, the material properties of the coating fluid and, to a decisive extent, the die gap parameters. By using vibration unit 16, the particle size can be selected larger in relation to the die gap. It is thus possible to select smaller gap thicknesses for a coating fluid with particles. A wide slot die thus allows a wider range of practicable wet film thicknesses. The use of the vibration unit also results in an influence on the stability of the homogeneity of the coating fluid, which increases the range of achievable processing speeds. The vibrations have a homogenizing influence on the creation and the characteristic of the boundary layer in the die gap, which is advantageous in connection with the process stability and manufacturing accuracy of the die gap of the wide slot die. The homogeneity of the wet film on the substrate can thus be optimized in width and length by the introduced mechanical vibrations in addition to the influence of the pressure drop.

It has been found that an optimum application of the coating fluid onto substrate 20 can be achieved by setting the frequency of the flow not in the ultrasonic range but well below it, preferably with an upper limit at 1 kHz. The set frequency, in particular in conjunction with a suitably selected mechanical amplitude, enables an introduction of kinetic energy into die body 2. This allows an improvement of the momentum exchange in the coating fluid, and thus, has a homogenizing and stabilizing effect in interaction with the flow. This behavior allows to reduce sedimentation zones and/or to break up particle agglomerates with the support of the shear forces of the flow or to prevent their formation for entry into die gap 7.

The die described above can be used in a wide range of different applications. Preferably, the wide slot die is adapted to all process and operating conditions as far as possible. The following applications are possible, for example:

### Battery Production

Using reel-to-reel equipment with integrated drying, slurry is coated on thin copper and aluminum foils with thicknesses of about 100 μm. The copper/aluminum foil forming the substrate is passed over a roller. The wide slot die is positioned against the roller by means of an applicator, e.g. in the so-called 9 o'clock position, wherein the wide slot die is positioned horizontally and centrally on the coating roller. The distance is approximately twice the wet film thickness, which places high demands on the concentricity of the roller, the tolerances of the die lip and the substrate. Battery slurries comprising water or solvent, carbon particles of various particle size ranges, binding agents, viscosity modifiers and active materials for the battery function are applied. The solid mass fractions of the fluids are typically in the range of 30% to 60%. Production speeds are approximately 10 m to 100 m per minute (web speed).

### Epoxy Resin UV Coating Application

Substrates referred to as sheets are coated using a coating table. The die is mounted vertically in an applicator with a downward discharge of the coating fluid. Robot arms can also be used to move the wide slot die. Substrate materials are plastic foils or glass. Wet film thicknesses are in the range of 10 μm. The coating media contain resins, in some cases volatile organic solvents, and more often particulate fractions, e.g. optical functional coatings. The processing is sequential, wherein a drying occurs through the thin layers without a dryer, for example in the case of a UV coating by means of a UV lamp. Production speeds are in the range of 0.01 to 5 m/min of relative speed of the die to the substrate. The requirements for application tolerances are very high in some cases.

### Curtain Application

In addition to methods in which the wide slot die is coating directly very close to the substrate, there is the option of operating the wide slot die at a high mass flow rate so that a curtain is formed at the exit opening. This curtain is a uniform thin falling film of liquid. The curtain falls onto the substrate, which is moved through the curtain. Distances of more than 10 cm are possible. Characteristics of the method are the fast substrate speed enabled by the curtain formation and good traverse distribution properties. Wet film thicknesses in the range of 50 μm and more are possible. The formation and the stability of a curtain are determined by the fluid parameters.

### LIST OF REFERENCE SIGNS

1 wide slot die
2 die body
3 die half
4 die half
5 die foil (foil)
6 die interior chamber
7 die gap
7a wall (inner wall of gap)
7b wall (inner wall of gap)
7L die gap opening
9 die lip
10 fastening device
11 first retaining element
11F retaining extension
12 second retaining element
12F engagement extension
13 fixing element
14 damper element
15 damper element
16 vibration device
20 substrate
TR transport direction
b width direction
q transverse direction
h height direction

1. A wide slot die for applying a fluid provided with particles, which comprises:
a die body defining a die interior chamber configured to receive a fluid provided with particles
a die gap defined by two walls, wherein a fluid provided with particles can be discharged from the die interior chamber onto a substrate which is in motion relative to the wide slot die in a transport direction, and;
a vibration device which is mechanically coupled to the die body in order to vibrate the die gap and the fluid located in the die interior chamber and provided with the particles,
wherein the vibration device is adapted to excite the die body with an upper limit frequency of 1 kHz.

2. The wide slot die according to claim 1, wherein the vibration device is adapted to excite the die body with a lower limit frequency of at least 1 Hz.

3. The wide slot die according to claim 1, wherein the mechanical amplitude of the vibration device in relation to the nominal diameter of the particles contained in the fluid is greater than or equal to 0.1.

4. The wide slot die according to claim 1, wherein the mechanical amplitude of the vibration device is at most 5 mm.

5. The wide slot die according to claim 1, wherein the mechanical amplitude of the vibration device acts in a transverse direction of the die body corresponding to the transport direction.

6. The wide slot die according to claim 1, wherein the mechanical amplitude of the vibration device acts in a height direction of the die body.

7. The wide slot die according to claim 1, wherein the fluid provided with particles is structurally viscous.

8. The wide slot die according to claim 1, wherein the die gap has a width of between 10 mm and 5 m in a width direction extending transversely to the transport direction.

9. The wide slot die according to claim 1, wherein the die gap has a slot width between 10 μm and 2.5 mm.

10. The wide slot die according to claim 1, further comprising a fastening device mechanically fixed to the die body via damper elements.

11. A method of operating a wide slot die for applying a fluid provided with particles, comprising:
providing a wide slot die having a die body, wherein the die body defines a die interior chamber configured to receive a fluid provided with particles, a die gap defined by two walls, wherein a fluid provided with particles can be discharged onto a substrate in motion relative to the wide slot die in a transport direction, and having a vibration device which is mechanically coupled to the die body in order to vibrate the die gap; and
actuating the vibration device such that the die body is excited with an upper limit frequency of at most 1 kHz.

12. The method according to claim 11, wherein the vibration device is actuated such that the die body is excited with a lower limit frequency of at least 1 Hz.

13. The method according to claim 11, wherein the mechanical amplitude of the vibration device is set to be greater than or equal to 0.1 in relation to the nominal diameter of a fluid provided with particles.

14. The method according to claim 13, wherein the mechanical amplitude of the vibration device is set to be at most 5 mm.
